(19) United States
(12) Patent Application Publication
(10) Pub. No.: US 2004/0005809 A1
(43) Pub. Date: Jan. 8, 2004

(54) Electromagnetic induction-type connector

(75) Inventor: Yasuhiro Suzuki, Susono-shi (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/443,846

(22) Filed: May 23, 2003

(30) Foreign Application Priority Data
May 24, 2002 (JP) P2002-151370

(51) Int. Cl. H01R 13/00

(52) U.S. Cl. 439/485

(57) ABSTRACT

An electromagnetic induction-type connector for feeding electric power or a signal by a mutual induction action, includes a first connector, including a first core member which has a primary-side core and a primary-side coil, a second connector, including a second core member which has a secondary-side core and a secondary-side coil, the second core member producing an induction electromotive force in accordance with the first core member, and at least one of a first metal case and a second metal case. The first metal case is directly contacted with the first core member, and includes a receiving portion receiving a circuit board to which the primary-side coil is electrically connected and includes a contact portion contacting with a connector mounting portion. The second metal case is directly contacted with the second core member, and includes a receiving portion receiving a circuit board to which the secondly-side coil is electrically connected and includes a contact portion contacting with a connector mounting portion. A heat produced in the first core member and the second core member by the mutual induction action is radiated to the connector mounting portion through the contact portion.

### BACKGROUND OF THE INVENTION

This invention relates to an electromagnetic induction-type connector in which two members of a vehicle are brought into proximity to each other so as to feed electric power or a signal from one of the two members to the other by mutual induction.

One well-known electromagnetic induction-type connector of this kind is used for supplying electric power between two members such as a car body and a door of a vehicle. More specifically, a first connector 4 of an electromagnetic induction-type connector is provided at a boarding port 3 in a car body 2 of a vehicle 1, as shown in FIGS. 13 and 14. A second connector 6 of the electromagnetic induction-type connector is mounted on a door 5 for opening and closing the boarding port 3.

The first connector 4 is provided with a guide mechanism 9 including a recess 7 and a moving base 8. A primary core 10 is supported by this guide mechanism 9 so as to slide (in directions of opening and closing of the door 5). Coil springs 11 are provided between the bottom of the recess 7 and the moving base 8. Further, an annular permanent magnet 12 is mounted on that side of the moving base 8 on which the primary core 10 is mounted.

The primary core 10 includes a disk portion 13, fixedly secured to the moving base 8, and a cylindrical portion 14 formed on and projecting from a central portion of the disk portion 13. A primary coil 15, including a winding of a wire, is wound around the cylindrical portion 14.

The second connector 6 includes a secondary core 18 having a cylindrical wall 16 and a bottom wall 17. A secondary coil 19 is provided on an inner face of the cylindrical wall 16, and this secondary coil 19 has an internal space, and the cylindrical portion 14 of the primary core 10 and the primary coil 15 can be inserted into and withdrawn from this internal space. A permanent magnet 20, similar to the permanent magnet 12 of the first connector 4, is provided at the second connector 6, and is disposed around an open end or edge of the cylindrical wall 16 in closely-spaced relation thereto.

In the above construction, when the door 5 is closed relative to the car body 2, the primary core 10 and the secondary core 18 abut against each other. The permanent magnets 12 and 20 attract each other, and the primary core 10 and the secondary core 18 are coupled or joined together in close proximity to each other. As a result, mutual induction is produced between the primary coil 15 and the secondary coil 19, so that electric power begins to be supplied from the car body 2 to the door 5.

In the electromagnetic induction-type connector, heat is generated by mutual induction, and therefore this connector has several problems described below.

First, when the connector is installed at a position where a person touches it, the increase of the temperature of the cores and coils must be suppressed in order to secure safety, and therefore there is encountered a problem that it is impossible to supply a large amount of electric power. Secondly, a temperature control device (protection circuit) is needed for suppressing the increase of the temperature of the cores and coils, and also the electromagnetic induction-type connector must be formed, using a heat-resistant material, which invites a problem that this affects the cost.

Incidentally, the Applicant of the present application has made an attempt to deal with the above problems by providing radiation fins on the electromagnetic induction-type connector. However, this attempt has drawbacks that the provision of the radiation fins increases the space and weight and that the resultant product is expensive (by the addition of the radiation fins). Therefore, this attempt has not been adopted.

### SUMMARY OF THE INVENTION

It is therefore a first object of the present invention to provide an electromagnetic induction-type connector having such a heat radiation structure that a large amount of electric power can be supplied, and also the increase of the cost can be suppressed. Second object is to provide an electromagnetic induction-type connector provided with the type of heat radiation structure which can suppress the increase of the space and weight.

In order to achieve the above object, according to the present invention, there is provided an electromagnetic induction-type connector for feeding electric power or a signal by a mutual induction action, comprising:

a first connector, including a first core member which has a primary-side core and a primary-side coil;

a second connector, including a second core member which has a secondary-side core and a secondary-side coil, the second core member producing an induction electromotive force in accordance with the first core member; and

at least one of a first metal case and a second metal case,

wherein the first metal case is directly contacted with the first core member, and includes a receiving portion receiving a circuit board to which the primary-side coil is electrically connected and includes a contact portion contacting with a connector mounting portion;

wherein the second metal case is directly contacted with the second core member, and includes a receiving portion receiving a circuit board to which the secondly-side coil is electrically connected and includes a contact portion contacting with a connector mounting portion; and

wherein a heat produced in the first core member and the second core member by the mutual induction action is radiated to the connector mounting portion through the contact portion.

In the above configuration, when the two members on which the first connector and the second connector is provided respectively are brought into proximity to each other, the first and second connectors are brought into proximity to or abut with each other. In this condition, when the primary-side coil of the first connector is excited, an induction electromotive force is produced in the second connector, thereby supplying electric power or transmitting a signal. Heat, produced by the mutual induction, is radiated to the directly-connected metal case, and is discharged to the connector mounting portion via the contact portion of the metal case.

Therefore, the increase of the temperature of the core and coil can be suppressed during the supply of the electric power or during the transmission of the signal. Therefore, there is achieved an advantage that a large amount of electric power can be supplied. And besides, in the invention, the fine temperature control for suppressing the increase of the temperature of the coil and core is not necessary, and an inexpensive material can be used. Therefore, there is achieved an advantage that the increase of the cost can be suppressed. Furthermore, in the invention, the heat radiation can be effected, utilizing the case for receiving the circuit board. Therefore, the increase of the space and weight can be suppressed, and also the need for the provision of additional parts is obviated, thereby achieving an advantage that the increase of the cost can be suppressed.

Preferably, a thermal conductive filler is filled in a gap between the primary-side core and the primary-side coil.

Preferably, wherein a thermal conductive filler is filled in a gap between the secondary-side core and the secondary-side coil.

In the above configuration, the heat, produced in the primary side and the secondary side coil, is radiated to the core via the filler. Then, the heat, is transferred to the metal case, and is discharged to the corresponding connector mounting portion via the contact portion. Thanks to the provision of the filler, the heat transfer between the core and the coil is effected efficiently.

Preferably, the first metal case has a thermal conductive portion directly contacting the primary-side coil.

Preferably, the second metal case has a thermal conductive portion directly contacting the secondary-side coil.

In the above configurations, the heat, produced in the coils, is radiated also to the thermal conductive portion of the metal case held in direct contact with the coils. The heat transfer is effected efficiently by the thermal conductive portion.

Preferably, a waterproof and heat radiation sheet is provided on the contact portion so that the sheet is held between the contact portion and the connector mounting portion.

In the above configuration, a waterproof seal is formed between the contact portion of the metal case and the connector mounting portion while maintaining a heat-radiating ability.

Preferably, the contact portion is fixed on the connector mounting portion by a connector fixing member.

In the above configuration, the contact portion of the metal case, together with the electromagnetic induction-type connector, is fixed to the corresponding connector mounting portion in such a manner that the contact portion is held between the connector fixing portion and the connector mounting portion. The contact portion is always held in contact with the connector mounting portion so as to positively radiate the heat.

Preferably, a electronic part mounted on the circuit board is contacted with the first metal case.

In the above configuration, the heat, produced in the electronic part on the circuit board, is radiated to the metal case, and is discharged to the corresponding connector mounting portion via the contact portion of this metal case. Namely, there is achieved the advantage that heat, produced in the electronic parts which generates heat on the circuit board, is discharged to the corresponding connector mounting portion, thus suppressing the temperature rise due to other factor.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a cross-sectional view showing one preferred embodiment of an electromagnetic induction-type connector of the present invention;

FIG. 2 is an exploded, perspective view of a first connector;

FIG. 3 is a front-elevational view of the first connector;

FIG. 4 is a rear view of the first connector;

FIG. 5 is a side-elevational view of the first connector;

FIG. 6 is a cross-sectional view taken along the line A-A of FIG. 3;

FIG. 7 is a cross-sectional view taken along the line B-B of FIG. 3;

FIG. 8 is a cross-sectional view taken along the line C-C of FIG. 3 (That portion within a circle is an enlarged, cross-sectional view of an important portion);

FIG. 9 is a cross-sectional view showing a modified example of the electromagnetic induction-type connector;

FIG. 10 is a rear view of a first connector shown in FIG. 9;

FIG. 11 is a side-elevational view of the first connector shown in FIG. 9;

FIG. 12 is a block diagram showing one example of an electric power supply system for a vehicle provided with the electromagnetic induction-type connectors shown in FIG. 1;

FIG. 13 is a perspective view showing a side portion of a related vehicle;

FIG. 14 is a cross-sectional view of a related electromagnetic induction-type connector;

### DETAILED DESCRIPTION OF THE PREFERRED EMBODIMENTS

A preferred embodiment of the present invention will now be described with reference to the drawings.

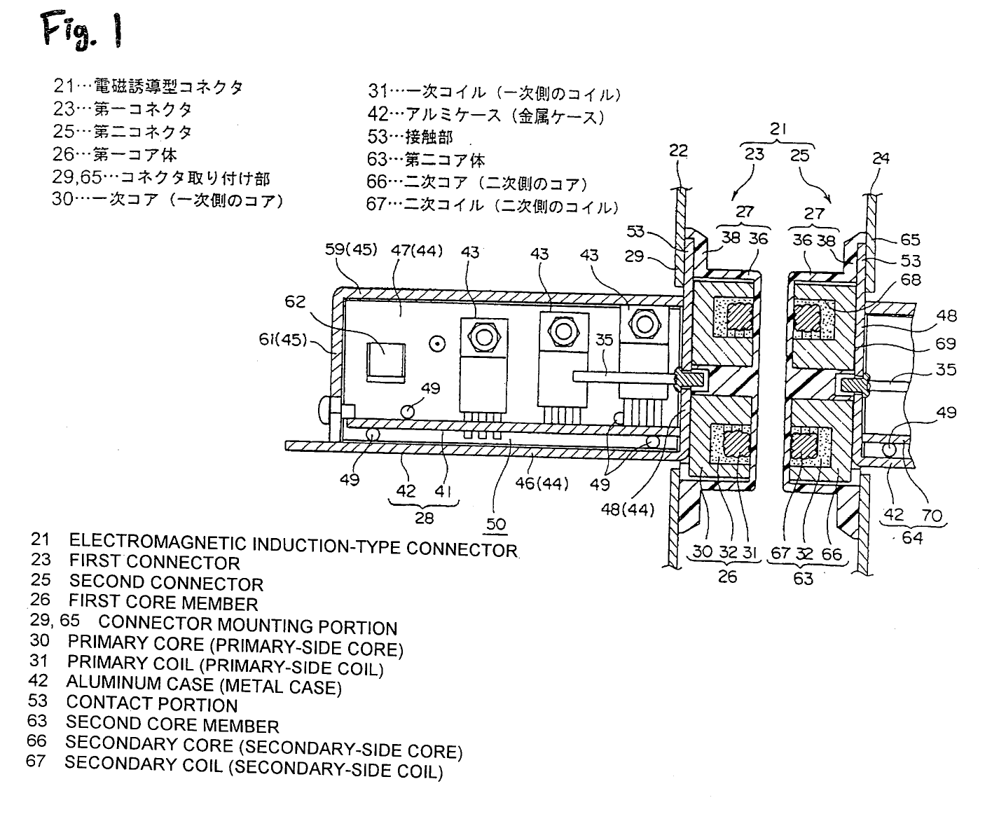

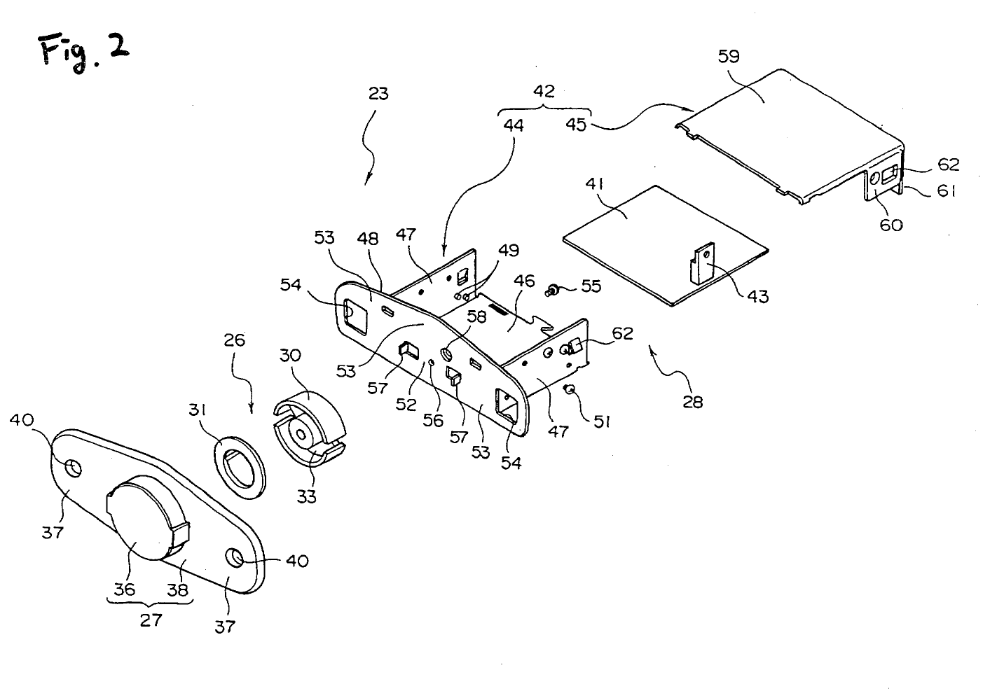

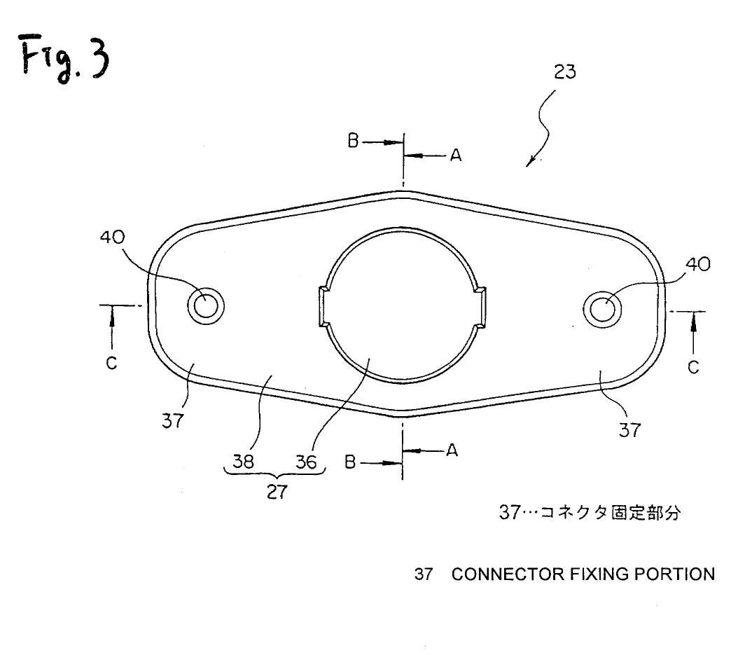

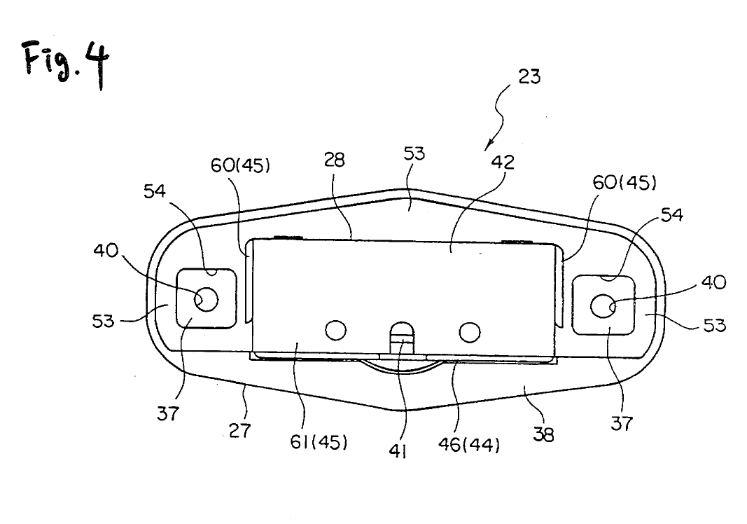

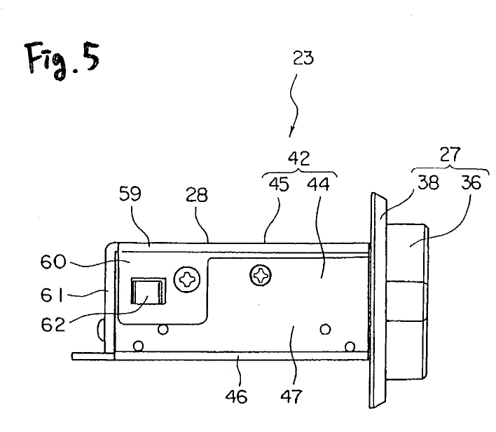

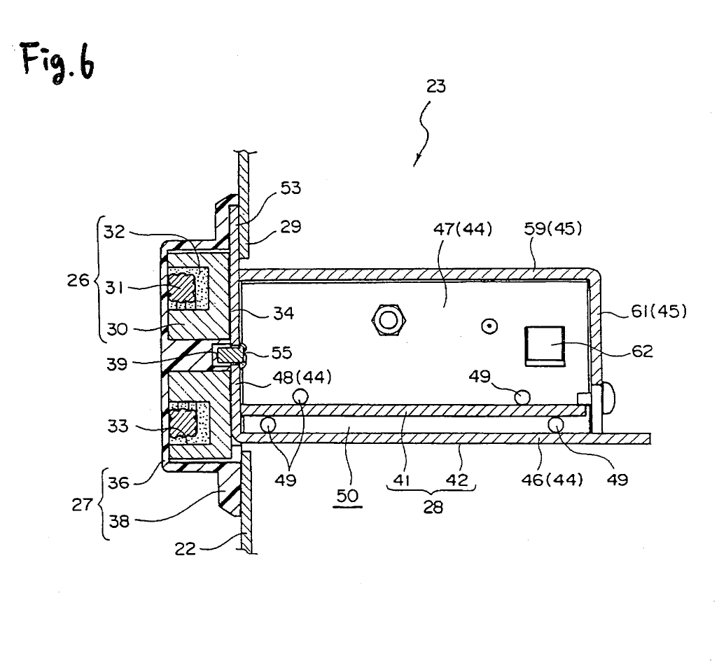

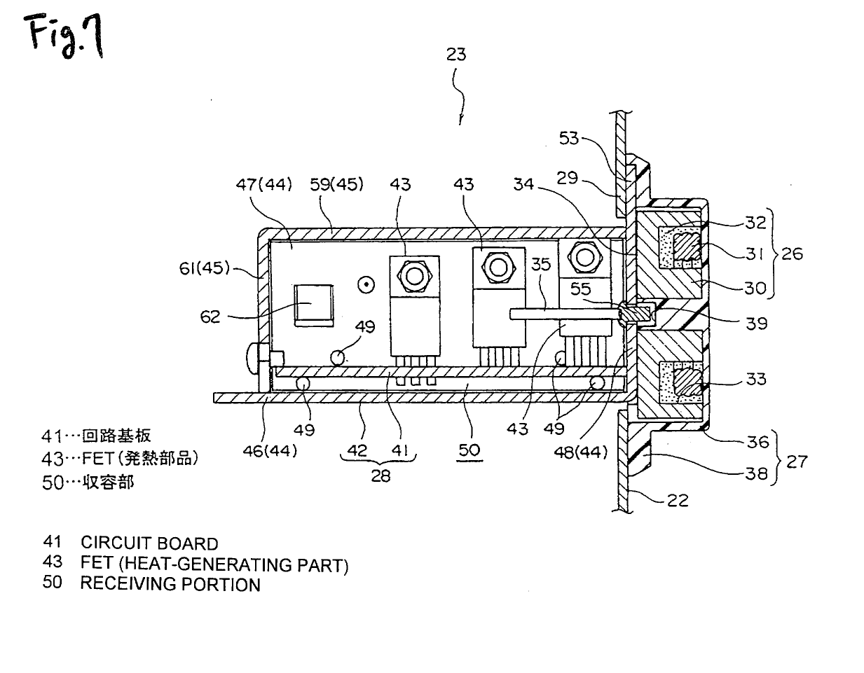

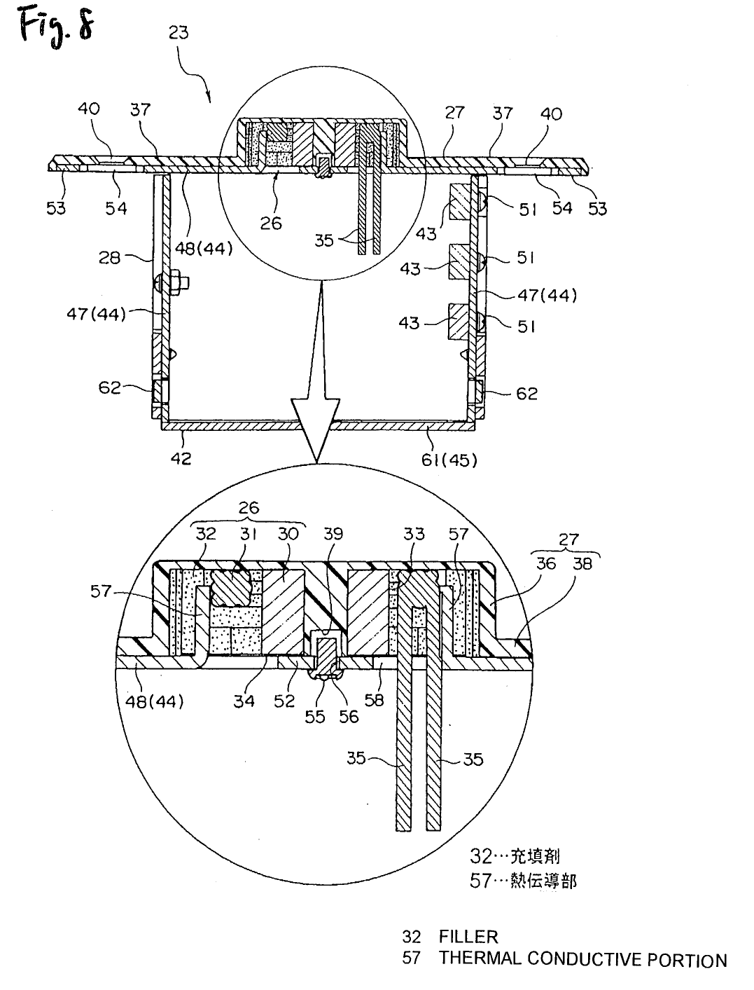

FIG. 1 is a cross-sectional view showing one preferred embodiment of an electromagnetic induction-type connector of the present invention. FIG. 2 is an exploded, perspective view of a first connector, FIG. 3 is a front-elevational view of the first connector, FIG. 4 is a rear view of the first connector, FIG. 5 is a side-elevational view of the first connector, FIG. 6 is a cross-sectional view taken along the line A-A of FIG. 3, FIG. 7 is a cross-sectional view taken along the line B-B of FIG. 3, and FIG. 8 is a cross-sectional view taken along the line C-C of FIG. 3 (That portion within a circle is an enlarged, cross-sectional view of an important portion).

In FIGS. 1 to 8, reference numeral 21 denotes the electromagnetic induction-type connector. This electromagnetic induction-type connector 21 includes the first connector 23 provided at a boarding port 22 in a car body of a vehicle, and a second connector 25 provided at a peripheral edge portion 24 of a door of the vehicle. The electromagnetic induction-type connector 21 is so constructed that electric power can be supplied (or a signal can be transmitted) from the car body to the door by mutual induction.

The first connector 23 includes a first core member 26, and a main case 27 provided at a front side of the first core member 26. A primary coil oscillation drive control device 28 provided at a rear side of the first core member 26. The first connector 23 is fixedly secured to a generally hole-like connector mounting portion 29, formed at the boarding port 22, by suitable fixing member (bolts in this embodiment).

The first core member 26 includes a primary core (primary-side core) 30, a primary coil (primary-side core) 31 received in the primary core 30, and a thermally-conductive filler 32 filled in a gap between the primary core 30 and the primary coil 31. The primary core 30 is formed, for example, by sintering ferrite powder, and this primary core 30 has an annular groove 32 of a channel-shaped cross-section formed in one side (face) thereof. The other side (face) 34 of the primary core 30 is formed into a flat face for intimate contact with an aluminum case 42 described later. The primary coil 31 is formed by winding a wire, and this primary coil 31 is so formed as to be received in the annular groove 32. For example, STYCAST 2850FY epoxy casting resin (produced by Emerson & Cumming) is used as the thermally-conductive filler 32. The filler 32 is filled in order to efficiently transfer heat, produced in the primary coil 31, to the primary core 30. Reference numeral 35 denotes a connection portion extending outwardly from the primary coil 31.

The main case 27 is molded of an insulative synthetic resin (insulator). The main case 27 includes a generally cap-like coupling portion 36 covering the one side and peripheral face of the first core member 26 in a watertight manner, and a flange 38 having a pair of connector fixing portions 37. The coupling portion 36 is fixedly secured to the first core member 26 by an adhesive or the like, and serves to protect the first core member 26 and also to reduce an impact upon contact. When the door is closed, a coupling portion 36 (described later) of the second connector 25 is brought into close proximity to (or into contact with) the coupling portion 36 of the first connector. In this embodiment, the coupling portion 36 is formed and located such that it projects beyond the boarding port 22 (although it is not limited to this arrangement). A fixing screw hole 39 is formed in the coupling portion 36. Bolt passage holes 40 each for the passage of a bolt (not shown) therethrough are formed through the connector fixing portions 37, respectively.

The primary coil oscillation drive control device 28 includes a circuit board 41 for controlling the excitation of the primary coil 31, and the aluminum case 42 (It is not limited to aluminum, and may be any other suitable metal in so far as it has good thermal conductivity.) which receives and fixes the circuit board 41, and is connected directly to the first core member 26 to function as radiating means. The connecting portion 35 of the primary coil 31 is connected to a predetermined portion of the circuit board 41 (The connected condition is not shown). A plurality of FETs (Field-Effect-Transistors) which generates a heat are mounted on the circuit board 41. Part of each of the FETs 43 contacts the aluminum casing 42, and is fixedly secured thereto. Heat, generated in each of the FETs 43, is transferred to the aluminum case 42, and is radiated therefrom.

The aluminum case 42 includes a case body 44, and a cover 45 attached to this case body 44. The case body 44 includes a bottom wall 46, a pair of side walls 47, and a core member-fixing wall 48. The side walls 47 are formed respectively at opposite (right and left) side edges of the bottom wall 46. The core member-fixing wall 48 is formed at a front edge of the bottom wall 46. The casing body 44 is formed by these walls. A plurality of projections 49 are formed on each of the side walls 47, and the circuit board 41 is fixed by these projections 49 as shown in the drawings. A receiving portion 50 for the circuit board 41 is formed within the aluminum case 42. Reference numeral 51 denotes bolts for fixing the plurality of FETs 43 to one side wall 47.

The core member-fixing wall 48 corresponds in shape to the flange 38 of the main case 27, and is a size smaller than this flange 38. The core member-fixing wall 48 includes a core member-direct connection portion 52, a contact portion 53, and bolt relief portions 54. The core member-direct connection portion 52 is formed into a flat face so as to intimately contact the other side (face) 34 of the primary core 30. A bolt passage hole 56 for the passage of a fixing bolt 55 therethrough is formed through a central portion of the core member-direct connection portion 52. The core member-direct connection portion 52 is fixedly secured to the coupling portion 36 by the bolt 55 threaded into a screw hole 39 formed in the coupling portion 36. A pair of thermal conductive portions 57 for direct contact with the primary coil 31 are formed respectively at opposite (right and left) sides of the core member-direct connection portion 52. In this embodiment, the thermal conductive portions 57 are formed by stamping and raising part of the core member-direct connection portion 52 (However, the formation is not limited to this method. The provision of the thermal conductive portions 57 is optional. It is preferred to provide these in order to achieve the efficient heat transfer.). Reference numerals 58 denotes a through hole through which the connection portion 35 of the primary coil 31 extends into the receiving portion 50.

The contact portion 53 is formed into a flat face so as to be held in contact with (preferably in intimate contact with) a peripheral edge portion of the connector mounting portion 29. The contact portion 53 serves to discharge the heat, transferred to the aluminum case 42, to the connector mounting portion 29. Naturally, it is preferred to increase the area of the contact portion 53 as much as possible. The contact portion 53 is formed immediately adjacent to the bolt relief portions 54, and is adapted to be held between the pair of connector fixing portions 37 of the main case 27 and the peripheral edge portion of the connector mounting portion 29 (The contact portion 53, when fixed, positively contacts the peripheral edge portion of the connector mounting portion 29. Heat radiation is positively effected.).

The cover 45 includes a top wall 59, a pair of side walls 60, and a rear wall 61. The side walls 60 are formed respectively at rear portions of opposite (right and left) side edges of the top wall 59. The rear wall 61 is formed at a rear edge of the top wall 59. The cover 45 is formed by these walls. A plurality of engagement portions 62 are formed at the side walls 47 of the case body 44 and the side walls 60 of the cover 45, and the side walls 47 are engaged respectively with the side walls 60 by these engagement portions 62.

The second connector 25 includes a second core member 63 which is brought into close proximity to the first core member 26 when the door is closed, and a main case 27 provided at a front side of the second core member 63, and a rectifier circuit device 64 provided at a rear side of the second core member 63. The second connector 25 is fixedly secured to a generally hole-like connector mounting portion 65, formed at an edge portion 24 of the door, by suitable fixing means (bolts in this embodiment). For the simplicity of description, those component parts, which are basically identical to those of the first connector 23 or common to the first and second connectors, will be designated respectively by the same reference numerals as used above.

The second core member 63 includes a secondary core (secondary-side core) 66, a secondary coil (secondary-side core) 67 received in the secondary core 66, and a thermally-conductive filler 32 filled in a gap between the secondary core 66 and the secondary coil 67. The secondary core 66 is formed, for example, by sintering ferrite powder, and this secondary core 66 has an annular groove 68 of a channel-shaped cross-section formed in one side thereof. The other side (face) 69 of the secondary core 66 is formed into a flat face for intimate contact with an aluminum case 42 (described later) of the secondary connector 25. The secondary coil 67 is formed by winding a wire, and this secondary coil 67 is so formed as to be received in the annular groove 68.

The main case 27 of the secondary connector 25 has the coupling portion 36 which is fixedly secured to the second core member 63 by an adhesive or the like, and this coupling portion 36 serves to protect the second core member 63 and also to reduce an impact upon contact. When the door is closed, the coupling portion 36 of the first connector 23 is brought into close proximity to (or into contact with) the coupling portion 36 of the main case 27 of the second connector 25.

The rectifier circuit device 64 includes a circuit board 70 having a known rectifier circuit, and the aluminum case 42 which receives the circuit board 70, and is connected directly to the second core member 63 to function as radiating means. The circuit board 70 is fixed to the aluminum case 42 of the second connector 25 by a plurality of projections 49. The second core member 63 is fixedly secured to a core member-fixing wall 48 of the aluminum case 42 of the second connector 25. A contact portion 53 of the aluminum case 42 of the second connector 25 is adapted to contact a peripheral edge portion of the connector mounting portion 65.

In the above construction, when the door is closed relative to the car body, the first connector 23 and the second connector 25 abut against each other, so that the coupling portions 36 of the first and second connectors 23 and 25 are brought into proximity to each other (or into contact with each other). When the primary coil 31 is excited, so that mutual induction is produced between the first core member 26 and the second core member 63, the two are electromagnetically connected or coupled together, and electric power begins to be supplied from the car body to the door. Heat, produced by the mutual induction, transfers to the directly-connected aluminum cases 42, and is discharged to the connector mounting portions 29 and 65 via the respective contact portions 53 of the aluminum cases 42.

As described above, the electromagnetic induction-type connector 21 of the invention has the heat radiation structure such that a large amount of electric power can be supplied, and the increase of the cost can be suppressed. And besides, the increase of the space and weight can be suppressed. Namely, in the electromagnetic induction-type connector 21 of the invention, heat, produced by the mutual induction, can be discharged to the connector mounting portions 29 and 65 via the directly-connected aluminum cases 42 (The increase of the temperature of the cores and coils can be suppressed during the supply of the electric power or during the transmission of the signal). And besides, any devices for fine temperature control (such as a protection circuit) do not need to be provided. In addition, an inexpensive material (for example, a material used for forming the main case 27) can be used. Furthermore, the cases for respectively receiving the circuit boards 41 and 70 contribute to the radiation of heat, and therefore the increase of the space and weight can be suppressed as compared with the case where radiating fins are additionally provided.

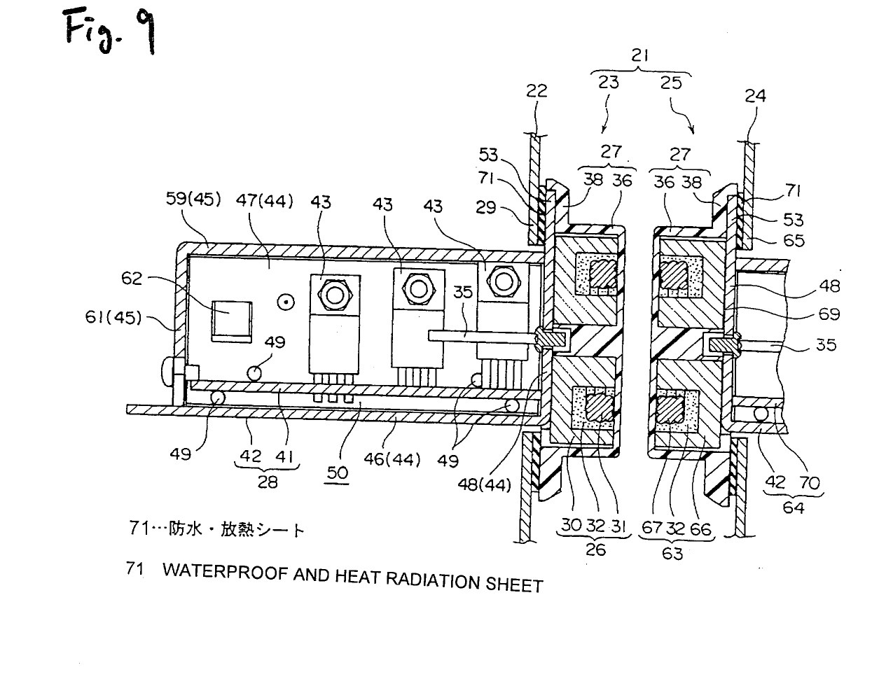

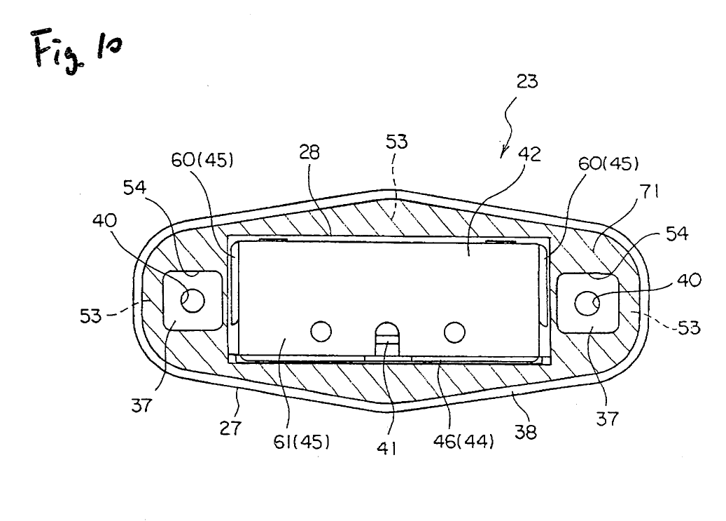

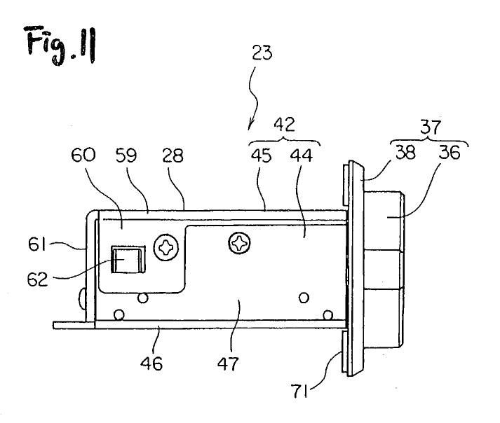

Next, a modified example of the above electromagnetic induction-type connector 21 will be described with reference to FIGS. 9 to 11. FIG. 9 is a cross-sectional view showing the modified example, FIG. 10 is a rear view of a first connector of FIG. 9, and FIG. 11 is a side-elevational view of the first connector of FIG. 9.

In FIGS. 9 to 11, the electromagnetic induction-type connector 21 includes waterproof and heat radiation sheets 71 each held between the connector and the corresponding connector mounting portion 29, 65. Each of the waterproof and heat radiation sheets 71 is provided over the contact portion 53 of the corresponding aluminum case 42 and the flange 38 of the corresponding main case 27 (see a hatching portion in FIG. 10), and serves to prevent the intrusion of moisture while maintaining a heat-radiating ability (The waterproof effect is secured). For example, TC-TX (silicone rubber sheet, TC series, produced by Shin-Etsu Chemical Co., Ltd.) is used as the waterproof and heat radiation sheet 71.

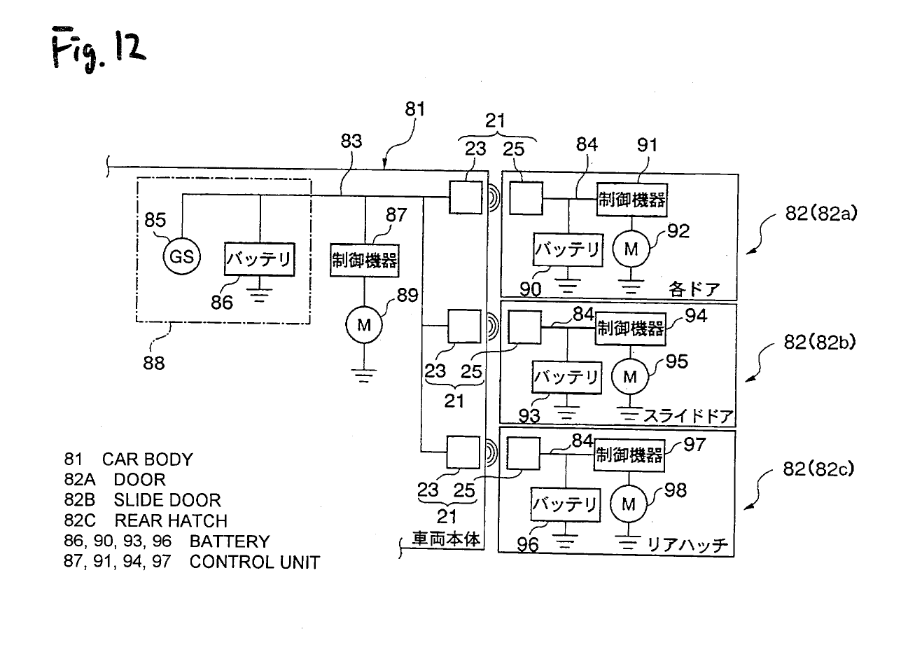

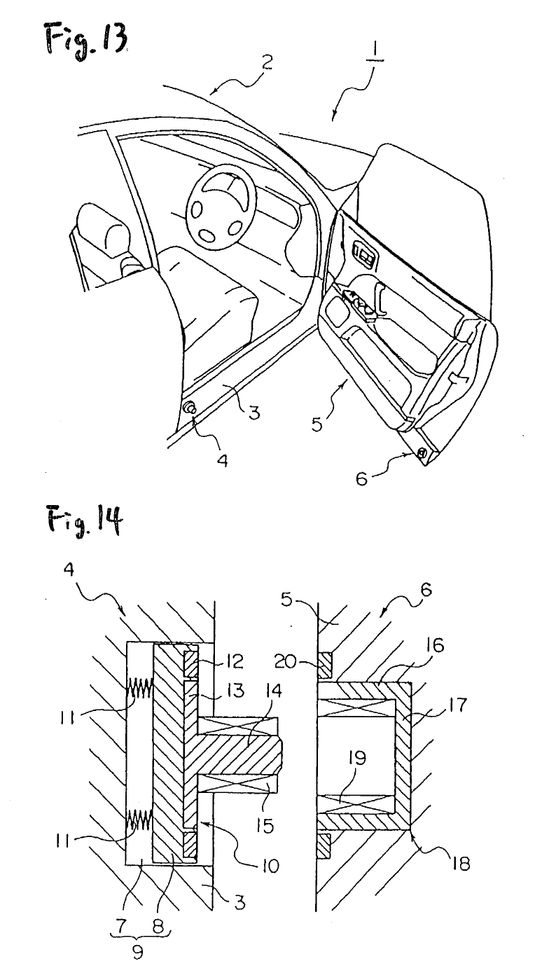

One example of an electric power supply system for a vehicle, provided with the above electromagnetic induction-type connectors 21, will be described with reference to FIG. 12. FIG. 12 is a block diagram of this example.

In FIG. 12, a plurality of door bodies 82 are mounted on a car body 81 of the vehicle so as to be opened and closed relative to this car body 81. The electromagnetic induction-type connector 21 for supplying electric power from the car body 81 to the corresponding door body 82 by mutual induction is provided at a door-connecting portion between the car body 81 and each of the door bodies 82. The number of the electromagnetic induction-type connectors 21 corresponds to the number of the door bodies 82, and each of these connectors 21 includes the first connector 23 mounted on the car body 81, and the second connector 25 mounted on the corresponding door body 82. Each first connector 23 is connected to a power supply line 83 provided at the car body 81. Each second connector 25 is connected to a power supply line 84 provided at the corresponding door body 82.

The door bodies 82 are a driver's seat-side door 82a, an assistant driver's seat-side door 82a, a slide door 82b, and a rear hatch 82c, respectively.

The construction of each of the above parts will be described. In addition to the first connectors 23 and the power supply line 83, a generator 85, a battery 86, a control unit 87 and so on are mounted on the car body 81. The generator 85 and the battery 86 are mounted within an engine room 88, and the battery 86 is charged with electric power produced by the generator 85. The power supply line 83 is connected to the battery 86, and electric power is supplied from this battery to the control unit 87. For example, a motor 89 is connected to the control unit 87.

The oscillation (driving) of each first connector 23 is controlled by the primary coil oscillation drive control device 28 (not shown. See FIG. 1). The primary coil oscillation drive control device 28 is connected to the power supply line 83.

In addition to the second connector 25 and the power supply line 84, a battery 90, a control unit 91 and so on are mounted on the door 82a. The battery 90 is charged with an induction electromotive force, produced in the second connector 25, via a rectifier circuit (not shown) and a charging circuit (not shown). The power supply line 84 is connected to the battery 90. The control unit 91 is connected to the power supply line 84, and is supplied with electric power from this power supply line. For example, a motor 92 is connected to the control unit 91.

In addition to the second connector 25 and the power supply line 84, a battery 93, a control unit 94 and so on are mounted on the slide door 82b. The battery 93 is charged with an induction electromotive force, produced in the second connector 25, via a rectifier circuit (not shown) and a charging circuit (not shown). The power supply line 84 is connected to the battery 93. The control unit 94 is connected to the power supply line 84, and is supplied with electric power from this power supply line. For example, a motor 95 is connected to the control unit 94.

In addition to the second connector 25 and the power supply line 64, a battery 96, a control unit 97 and so on are mounted on the rear hatch 82c. The battery 96 is charged with an induction electromotive force, produced in the second connector 25, via a rectifier circuit (not shown) and a charging circuit (not shown). The power supply line 84 is connected to the battery 96. The control unit 97 is connected to the power supply line 84, and is supplied with electric power from this power supply line. For example, a motor 98 is connected to the control unit 97.

In the above construction, each electromagnetic induction-type connector 21 operates in the following manner. First, when a key (not shown) is inserted into an ignition switch, and turns on this ignition switch, electric power is supplied to the primary coil oscillation drive control device 28 (not shown. See FIG. 1) connected to the power supply line 83. When electric power is thus supplied to the primary coil oscillation drive control device 28, the primary coil 31 (not shown. See FIG. 1) of each first connector 23 is driven or oscillated by the primary coil oscillation drive control device 28, so that an AC electromotive force is produced in the primary coil 31.

When the door 82a is closed relative to the car body 81, an induction electromotive force is produced in the second connector 25 through mutual induction between the second connector and the first connector 23. The battery 90 is charged with the thus produced induction electromotive force via the rectifier circuit (not shown) and the charging circuit (not shown). When the door 82a is open relative to car body 81, electric power is supplied from the battery 90 to the power supply line 84. Heat, produced by the mutual induction, is discharged (radiated) to the car body 81 and the door 82a.

When the slide door 82b is closed relative to the car body 81, an induction electromotive force is produced in the second connector 25 through mutual induction between the second connector and the first connector 23. The battery 93 is charged with the thus produced induction electromotive force via the rectifier circuit (not shown) and the charging circuit (not shown). When the slide door 82b is open relative to car body 81, electric power is supplied from the battery 93 to the power supply line 84. Heat, produced by the mutual induction, is discharged (radiated) to the car body 81 and the slide door 82b.

When the rear hatch 82c is closed relative to the car body 81, an induction electromotive force is produced in the second connector 25 through mutual induction between the second connector and the first connector 23. The battery 96 is charged with the thus produced induction electromotive force via the rectifier circuit (not shown) and the charging circuit (not shown). When the rear hatch 82c is open relative to car body 81, electric power is supplied from the battery 96 to the power supply line 84. Heat, produced by the mutual induction, is discharged (radiated) to the car body 81 and the door 82c.

Various modifications can be made within the scope of the invention. Namely, this invention is explained by using the car body and the door body (the door, the slide door and the rear hatch), respectively, however these are not limited to the present invention. Such examples include a steering of a door (separate side: a steering portion), and a seat of a vehicle (separate side: a seat portion). The invention can be applied to any suitable two members, related to a vehicle, in so far as the supply of electric power (or the transmission of a signal) need to be effected between the two members by mutual induction. In the above embodiments, although the heat radiation structure is provided in each of the first core member 26 and the second core member 63, the heat radiation structure is not limited to this arrangement.

What is claimed is:

1. An electromagnetic induction-type connector for feeding electric power or a signal by a mutual induction action, comprising:
a first connector, including a first core member which has a primary-side core and a primary-side coil;
a second connector, including a second core member which has a secondary-side core and a secondary-side coil, the second core member producing an induction electromotive force in accordance with the first core member; and
at least one of a first metal case and a second metal case,
wherein the first metal case is directly contacted with the first core member, and includes a receiving portion receiving a circuit board to which the primary-side coil is electrically connected and includes a contact portion contacting with a connector mounting portion;
wherein the second metal case is directly contacted with the second core member, and includes a receiving portion receiving a circuit board to which the secondly-side coil is electrically connected and includes a contact portion contacting with a connector mounting portion; and
wherein a heat produced in the first core member and the second core member by the mutual induction action is radiated to the connector mounting portion through the contact portion.

2. The electromagnetic induction-type connector as set forth in claim 1, wherein a thermal conductive filler is filled in a gap between the primary-side core and the primary-side coil.

3. The electromagnetic induction-type connector as set forth in claim 1, wherein a thermal conductive filler is filled in a gap between the secondary-side core and the secondary-side coil.

4. The electromagnetic induction-type connector as set forth in claim 1, wherein the first metal case has a thermal conductive portion directly contacting the primary-side coil.

5. The electromagnetic induction-type connector as set forth in claim 1, wherein the second metal case has a thermal conductive portion directly contacting the secondary-side coil.

6. The electromagnetic induction-type connector as set forth in claim 1, wherein a waterproof and heat radiation sheet is provided on the contact portion so that the sheet is held between the contact portion and the connector mounting portion.

7. The electromagnetic induction-type connector as set forth in claim 1, wherein the contact portion is fixed on the connector mounting portion by a connector fixing member.

8. The electromagnetic induction-type connector as set forth in claim 1, wherein a electronic part mounted on the circuit board is contacted with the first metal case.

9. The electromagnetic induction-type connector as set forth in claim 1, wherein a electronic part mounted on the circuit board is contacted with the second metal case.
